(19) United States
(12) Patent Application Publication
(10) Pub. No.: US 2022/0194296 A1
(43) Pub. Date: Jun. 23, 2022

(54) Vehicle systems and methods for assistance drivers to reduce reflective light interference from rear sides

(71) Applicant: Hoi Chue HUNG, Hong Kong (HK)

(72) Inventor: Hoi Chue HUNG, Hong Kong (HK)

(21) Appl. No.: 17/128,026

(22) Filed: Dec. 19, 2020

(51) Int. Cl. B60R 1/08; G02F 1/163; G06K 9/00

(52) U.S. Cl. CPC B60R 1/083; G02F 1/163; G06K 9/00845; G06K 9/00288; G06K 9/00597; G06K 9/00335; G06K 9/00302

(57) ABSTRACT

A vehicle system includes a plurality of dimmable mirrors, a camera configured to capture images of a driver of the vehicle, and a processor coupled to the camera configured to identify any eyes squinting action of the driver relating to the eye and any sudden head side movements when detected the eyes squinting action of the driver. In accordance with a determination that the identification does satisfy the mirror dimming criteria, dim a dimmable mirror based on one or more characteristics of the facial expressions of the driver including a direction of turning of the head of the driver and whether the eye is a left eye or right eye.

### FIELD OF THE INVENTION

The presently disclosed technology generally relates to systems and methods that use dimmable mirrors and cameras in vehicles. In one embodiment, a system including a dimmable mirror and a camera is configured to capture images of a driver of the vehicle is disclosed. The camera is configured to identify any eyes squinting action of the driver relating to the eye and any sudden head side movements when detected the eyes squinting action of the driver.

### BACKGROUND OF THE DISCLOSED TECHNOLOGY

Vehicles, especially automobiles, increasingly include various internal or external cameras for enhancing drivers' or passengers' experiences in the vehicles. Sometimes, these cameras replace or augment the functionality of physical mirrors on the vehicle. Examples of any current and past disclosures include directing cameras on a vehicle to dynamically dim one or more mirrors (e.g., side view mirrors) on the vehicle to prevent or reduce glare, for the driver of the vehicle, caused by reflections of light (e.g., from headlights of trailing vehicles) from those mirrors. Prior means includes configuring to capture images of surroundings of the vehicle using cameras to determine if there is too much glare or bright light that may come from the back of a driver to determine if it is necessary to change the color of the rear mirror or side mirrors to reduce from high too much light applied to the driver, especially driving at night in the dark where too much reflection from the rear of a car can be very distracting to driver. However, capturing images from the surroundings including the rear of a vehicle has one major issue—privacy concerns because doing so would capture private information from others. As privacy concern would infringe a person's right and may give rise to liability, therefore, it is desirable to have an invention that would remove such concern but yet help reducing bright light or glare situations for drivers.

### SUMMARY OF THE INVENTION

A vehicle system is disclosed for assistance drivers to reduce reflective light interference from rear. The vehicle system discloses a plurality of dimmable mirrors, a camera configured to capture images of a driver of the vehicle, the images including facial expressions comprising an eye of the driver and head movement of the driver. The vehicle system discloses a processor coupled to the camera, the processor configured to identify, in the captured images, i) any eyes squinting action of the driver relating to the eye ii) any sudden head side movements when detected the eyes squinting action of the driver, and iii) any detection of glare or bright spots in the captured image shown on the face of the driver.

The identification of any eyes squinting action of the driver includes detection of changes of size of the eyes of the driver over a period of given time. On the other hand, the identification of any sudden head side movements includes an angle of tilting of the head of the driver from a normalized position captured in a previous image.

In accordance with a determination that the identification does satisfy the mirror dimming criteria, the processor signals to dim a dimmable mirror based on one or more characteristics of the facial expressions of the driver including i) a direction of turning of the head of the driver and ii) whether the eye is a left eye or right eye, wherein an amount of dimming the dimmable mirror is determined by an amount of the eyes squinting action of the driver including the change of the size of the eyes over a period of time, and wherein an amount of dimming the dimmable mirror is determined by level or degree of the sudden head side movements include the angle of tilting of the head of the driver from a normalized position captured in a previous image over a period of time and leave rest of the plurality of the dimmable mirrors unchanged.

In accordance with a determination that the one or more identification does not satisfy the mirror dimming criteria, the processor would forgo dimming the dimmable mirror.

According to another embodiment of the present invention, methods and systems are disclosed for assistance drivers to reduce reflective light interference from rear. In one embodiment, a method is disclosed in capturing images of a driver of a vehicle, wherein the images including facial expressions comprising i) an eye of the driver and ii) head movement of the driver. Said methods are designed in identifying, in the captured images, i) any eyes squinting action of the driver relating to the eye, ii) any sudden head side movements when detected the eyes squinting action of the driver, and iii) any detection of glare or bright spots in the captured image shown on the face of the driver. The identification of any eyes includes squinting action of the driver. The action may include detection of changes of size of the eyes of the driver over a period of given time. Wherein the identification of any sudden head side movements includes an angle of tilting of the head of the driver from a normalized position captured in a previous image. The processor further allows determining whether the identification may satisfy mirror dimming criteria, including a criterion that is satisfied when the plurality of dimmable mirrors are switched on. In accordance with a determination that the identification does satisfy the mirror dimming criteria, the processor signals a) dimming a dimmable mirror based on one or more characteristics of the facial expressions of the driver including: i) a direction of turning of the head of the driver and ii) whether the eye is a left eye or right eye, wherein an amount of dimming the dimmable mirror is determined by an amount of the eyes squinting action of the driver including the change of the size of the eyes over a period of time, and wherein an amount of dimming the dimmable mirror is determined by level or degree of the sudden head side movements include the angle of tilting of the head of the driver from a normalized position captured in a previous image over a period of time. In other cases, the processor would leave rest of the plurality of the dimmable mirrors unchanged.

In another embodiment, a system is disclosed. The system is used to provide drivers assistance to reduce reflective light interference from rear sides. The system is used in a vehicle and includes a plurality of dimmable mirrors, a camera and a processor. In one embodiment, the camera is configured to capture images of a driver of the vehicle, the images including facial expressions comprising i) an eye of the driver and ii) head movement of the driver. In the embodiment, the processor is coupled to the camera, the processor configured to identify, in the captured images, i) any eyes squinting action of the driver relating to the eye and ii) any sudden head side movements when detected the eyes squinting action of the driver. Moreover, the processor can be used to determine whether the identification may satisfy mirror dimming criteria, including a criterion that is satisfied when the plurality of dimmable mirrors are switched on.

In accordance with a determination that the identification does satisfy the mirror dimming criteria, the processor in the embodiment may be used to a) dim a dimmable mirror based on one or more characteristics of the facial expressions of the driver including i) a direction of turning of the head of the driver and ii) whether the eye is a left eye or right eye, and b) leave rest of the plurality of the dimmable mirrors unchanged. When it is determined that the one or more identification does not satisfy the mirror dimming criteria, then the processor would instruct dimming the dimmable mirror.

### BRIEF DESCRIPTION OF THE DRAWINGS

FIG. 1 illustrates an exemplary mirror dimming system according to an example of the disclosure.

FIG. 2 illustrates an exemplary vehicle system coupled to side mirrors and a rear mirror and with a processor that captures images of a driver according to examples of the disclosure.

FIG. 3 illustrates an exemplary mirror dimming system showing glare from the rear through reflective mirrors according to an example of the disclosure.

FIG. 4 illustrate a prior art example where capturing images to the rear of a vehicle may cause privacy concern.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Vehicles, especially automobiles, increasingly include various internal or external cameras for enhancing drivers' or passengers' experiences in the vehicles. Sometimes, these cameras replace or augment the functionality of physical mirrors on the vehicle. Examples of the disclosure are directed to using one or more cameras on a vehicle to dynamically dim one or more mirrors (e.g., side view mirrors) on the vehicle to prevent or reduce glare, for the driver of the vehicle, caused by reflections of light (e.g., from headlights of trailing vehicles) from those mirrors.

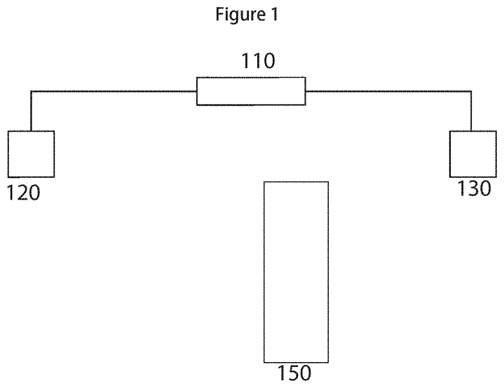

FIG. 1 illustrates an exemplary mirror dimming system according to examples of the disclosure. Mirror dimming system can correspond to a dimming system in a vehicle that includes a left side view mirror 120, a right side view mirror 130 and a rear view mirror 110. Rear view mirror 130 can include an optoelectronic diode, which can sense light incident upon it, and generate a voltage in response. One or more of left side view mirror 120, right side view mirror 130 and rear view mirror 110 can dim so as to reduce glare, for the driver of the vehicle, from the headlights of another vehicle (e.g., a trailing vehicle). Specifically, left side view mirror 120, right side view mirror 130 and/or rear view mirror 110 can be electrochromic, and can darken in response to a voltage applied to them, thus reducing discomfort to the driver of the vehicle from reflections of headlights of other vehicles from one or more of left side view mirror 120, right side view mirror 130 and rear view mirror 110. Dimming in system can be performed in response to optoelectronic diode detecting light incident upon it from, for example, headlights of a trailing vehicle. If optoelectronic diode detects such light incident upon it, it can transmit a corresponding signal (e.g., a voltage) to a controller of the vehicle to dim the rear view 110 and/or side view, mirrors according to the signal.

In some embodiments, one or more of mirrors may be replaced by camera and display systems in which, in lieu of mirrors, one or more cameras can capture images of the vehicle's surroundings (e.g., sides and rear), and one or more displays in the vehicle can display those images inside the vehicle for the driver's reference. For example, in one embodiment, a vehicle may not include rear view mirror (but may continue to include side view mirrors and due to safety regulations, for example), including a rear view camera and a display inside the vehicle that displays images from the rear view camera, the images corresponding to what would have been visible to the driver via a rear view mirror. Thus, in this alternative solution for detecting trailing headlights is needed to dim side view mirrors and to continue to reduce glare for the driver of the vehicle.

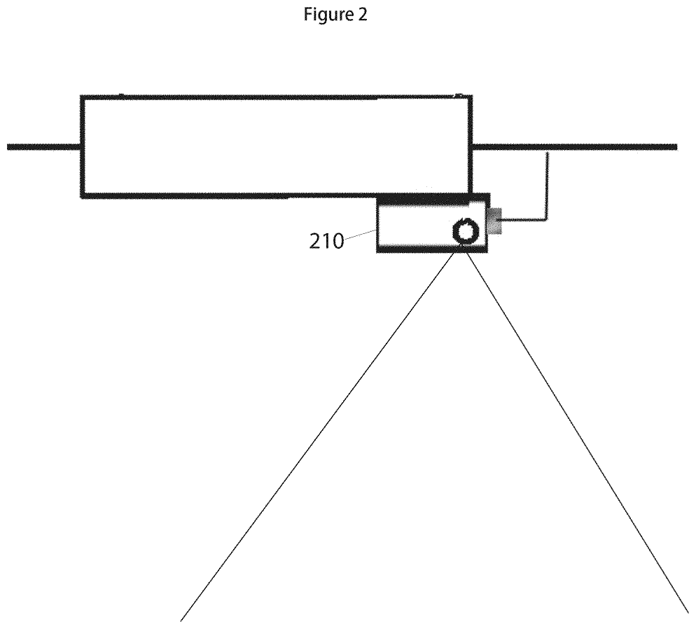

FIG. 2 illustrates an exemplary vehicle system coupled to side mirrors and a rear mirror and with a processor included in a camera 210 that captures images of a driver according to examples of the disclosure. The vehicle can be any kind of vehicle, such as a consumer automobile, an airplane, a boat, or an industrial automobile. The vehicle can include left side view mirror and ride side view mirror, as described with reference to FIG. 1, though vehicle may not even include a rear view mirror, in some embodiments. In lieu of a rear view mirror, the vehicle may include one or more cameras 210 for capturing images of the vehicle's surroundings, which can be transmitted to one or more displays inside the vehicle for the driver's reference. For example, a vehicle can include camera 210, which can capture images to the left and behind the vehicle (e.g., corresponding to a region visible from side view mirror), which can capture images to the right and behind the vehicle (e.g., corresponding to a region visible from side view mirror), and camera, which can capture images behind the vehicle (e.g., corresponding to a region visible from a rear view mirror, if the vehicle had such a mirror). In some examples, cameras, and can have relatively narrow fields of view (e.g., 120 degrees or less); thus, in some examples, vehicle can also include camera, which can provide relatively wide field of view (e.g., 180 degrees or more) images of the vehicle's rear/sides for use in parking operations, for example. It should be understood that the locations of cameras are illustrative. The cameras can be placed anywhere on the vehicle so long as to capture the desired view.

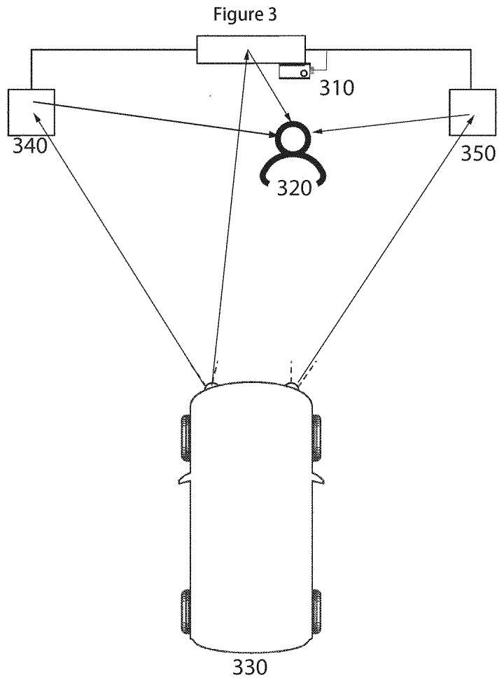

Because the vehicle containing the mirror dimming system of the present invention can optionally have side view mirrors but may not have a rear view mirror such as mirror in which an optoelectronic diode can be integrated to sense trailing headlights, in some embodiments, such as FIG. 3, a vehicle can utilize multiple cameras 310 to identify headlights that might reflect off of side view mirrors, those headlights glare caused by a vehicle from the rear 330 that may cause glare to the own driver 320 of the vehicle containing the mirror dimming system. The vehicle with the mirror dimming system can then dim one or more of side view mirrors 340 and 350 and, as appropriate, based on the images captured by one or more of cameras 310 and as will be described in more detail below.

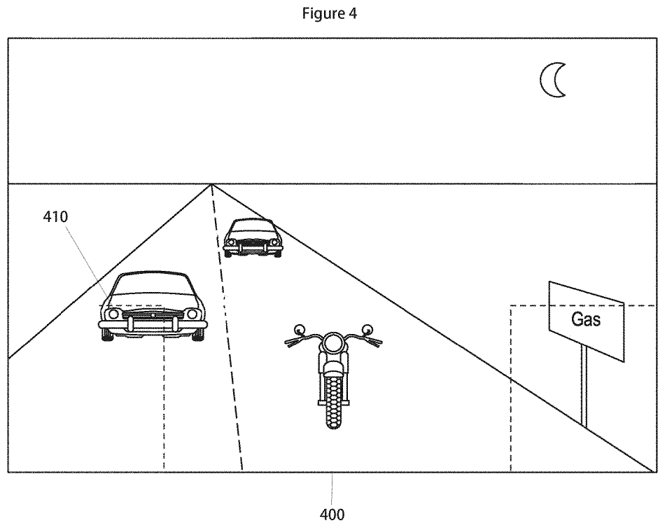

FIG. 4 illustrates prior exemplary composite images captured by one or more of cameras and according to examples of the disclosure. For example, image 400 can represent images captured by cameras 310, and of areas behind the vehicle containing the mirror dimming system. In image 400, in the example, the vehicle 410 from the rear produces strong glare from its headlights that may cause disturbance to the driver of the vehicle containing mirror dimming system of the present invention. It is understood that while the examples of the disclosure are described in the context of a composite image sourced from multiple cameras, in some examples, the image processing techniques disclosed below can be separately implemented on images captured by individual cameras. For example, image processing techniques described with reference to the left side of image can be performed on images captured by camera (e.g., corresponding to the rear-right of the vehicle) without generating composite image.

In some examples, the vehicle may only dim its side mirrors in response to detecting headlights in image, and not in response to detecting other sources of light. Further, the vehicle may assume that headlights will appear within the boundaries of road in image, and not outside of those boundaries. Thus, in some examples, the vehicle can identify the boundaries of road and/or horizon, and identify sources of light that are outside of the boundaries of road (or outside a predetermined distance of road) and/or above horizon as not being headlights, and, thus, as not triggering dimming of its side mirrors. Analogously, the vehicle can identify headlights as being headlights, and thus potentially triggering dimming of its side view mirrors, because headlights can be located within the boundaries of road and below horizon in image.

In some examples, in addition or alternatively to using road and/or horizon as boundaries or as defining regions in image to identify headlights, the vehicle can analyze the characteristics of various light sources in the image to identify light sources as being headlights or not. For example, headlights may appear like point sources of light in image, while other sources of light (e.g., moon and/or sign) may not appear as point sources of light. Therefore, the vehicle can identify moon and sign as not being point sources of light (and, thus, not headlights), and can identify headlights as being point sources of light (and, thus, headlights). In some examples, the vehicle may additionally or alternatively search for pairs of point sources of light in image, as would be the case for automobiles with two headlights, in identifying sources of light as being headlights or not. For example, the cameras can take a series of images over a period of time. An image processor in the vehicle can process the images to determine the relative positions of the two sources of light in these images and then determine whether the two sources of light are indeed headlights based on the relative positions. Accordingly, the vehicle can identify headlights as being headlights, and can identify moon and sign (and, perhaps, headlight) as not being headlights.

In some examples, not all sources of light that are identified as headlights may cause the vehicle to dim its side mirrors. Specifically, headlights that are not positioned such that they would reflect off of the vehicle's side view mirrors and into the driver's eyes may not cause glare for the driver of the vehicle, and thus, may not trigger dimming of the vehicle's side view mirrors. Therefore, in some examples, the vehicle can determine whether the sources of light it has identified as headlights are located within specified regions with respect to the vehicle (e.g., regions in image that correspond to regions in the vehicle's surroundings that are visible to the driver from the vehicle's side view mirrors). For example, the vehicle can determine whether headlights, after identifying them as headlights, are located within region (corresponding to an area that may cause glare via the vehicle's right side view mirror) or region (corresponding to an area that may cause glare via the vehicle's left side view mirror) in image. The vehicle can determine that headlight is located within region of image. As a result, the vehicle can determine that headlight is likely to cause glare for the driver of the vehicle, and can dim its side view mirrors based on the intensity of headlight. In some examples, the vehicle can independently dim its right side view mirror in response to detecting headlight in region, but not dim its left side view mirror in response to detecting headlight in region (e.g., because no headlight is detected in region). In some examples, in response to detecting different headlights in regions and of image, the vehicle can dim its right and left side view mirrors by different amounts based on the characteristics (e.g., intensities) of the headlights detected in those regions.

In some examples, in addition or alternatively to identifying headlights in image as described above, the vehicle can identify sources of light as being headlights or not based on their movements in image. For example, street lights may enter image from the top right and left corners of the image, and can move towards the center of the image over time, while headlights from other cars may not exhibit such behavior. Additionally or alternatively, headlights from trailing vehicles can move less than a threshold distance within image over a given amount of time (e.g., because trailing vehicles can be moving at close to the same speed as the vehicle), while lights from road signs or street lights can move greater than the threshold distance within the image over the given amount of time (e.g., because road signs or street lights can be stationary, while the vehicle can be moving). For example, it illustrates image after a predetermined amount of time has elapsed (i.e., the vehicle has moved further down road). Sign 308 has moved a relatively large distance in image (e.g., greater than a threshold distance), while headlights have moved relatively small distances in image (e.g., less than the threshold distance). As such, the vehicle can identify sign as not being a headlight.

In some examples, the region(s) in image that the vehicle associates with headlights can change as a function of the characteristics of the road on which the vehicle is traveling. For example, it illustrates image when the vehicle is on a curved road. Similar to as discussed with reference to the example, the vehicle can search for sources of light that are below horizon and/or within the boundaries of road to (potentially) identify such sources of light as headlights, while identifying sources of light above horizon and/or outside of the boundaries of road as not being headlights. However, the boundaries of road in the example can be at different locations in image than the boundaries of road, because road can be a curved road in the example. Therefore, the vehicle can, using appropriate image processing techniques, identify the boundaries of road, and can designate the region in image corresponding to the area within the boundaries of road as being the region in which sources of light can (potentially) be identified as headlights. This region can be different than the corresponding region in image. In some examples, the vehicle can additionally or alternatively determine these different regions in image based on detecting the steering angle of the vehicle (indicating the vehicle is driving on a curved road), based on the GPS coordinates of the vehicle (indicating, on a map, that the vehicle is on a curved road) and/or based on image processing of image or images from other cameras on the vehicle, such as front-facing cameras (determining, via image processing, that the vehicle is on a curved road).

In some examples, the vehicle can include one or more interior cameras that can be used for applications such as video conferencing or driver/passenger identification using facial recognition. In some examples, the vehicle can utilize these one or more interior cameras to determine whether light reflected from the vehicle's side mirrors is incident on the driver's face, and can control dimming of its side view mirrors accordingly. an example face of the driver of the vehicle is shown according to examples of the disclosure. The vehicle can, using one or more interior cameras and facial recognition techniques, identify the face of the driver of the vehicle. Then, the vehicle can determine whether light (e.g., light reflected from the vehicle's side view mirrors) is incident on the driver's face or eyes. For example, the vehicle can search for an area of light around the driver's face that has a shape that corresponds to the shapes of the vehicle's side view mirrors. The vehicle can then determine whether light overlaps with the driver's face. Light does overlap with the driver's face, so the vehicle can determine that one or both of its side view mirrors should be dimmed. In some examples, the vehicle may not make such as determination unless light overlaps with one or more of the driver's eyes, or is within a predetermined distance of the driver's eyes, in which case the vehicle can determine that one or both of its side view mirrors should be dimmed.

In some embodiments, some exemplary effects are shown after dimming the side view mirrors of a vehicle based on images captured by one or more cameras according to examples of the disclosure. In some examples, method is only performed while the vehicle's surroundings are dark (e.g., include less than a threshold amount of ambient light), and/or during specified hours of the day (e.g., between the hours of sunset and sunrise), because glare caused by headlights might not otherwise be an issue for the driver. In some examples, the vehicle can measure the ambient light in its surroundings using a light sensor on the vehicle (e.g., a light sensor used to illuminate automatic headlights), or can use image processing techniques (e.g., analyzing the brightness of pixels above the horizon over time) on images captured by on-board cameras to determine the ambient light in the vehicle's surroundings. Other manners of determining the ambient light in the vehicle's surroundings can also be utilized. In some examples, method can be performed irrespective of ambient light levels or the time of day.

In some examples, one or more of the methods for identifying sources of light as headlights described with can be employed by the vehicle. Additionally or alternatively, the vehicle can identify vehicle headlights as such based on analyzing the frequencies (e.g., flicker frequencies) of the light sources in the images. Sun light/natural light and street lights might have different frequencies of operation than vehicle headlights, which can be DC or flicker at specified frequencies. Therefore, the vehicle can identify the frequencies of operation of the light sources within the images, and can identify the light sources as being headlights or not based on those frequencies.

If no headlights are detected in the images, method can return to capture additional images of the vehicle's surroundings. If headlights are detected in the images, whether a glare condition is satisfied can be determined, such as described. For example, if the headlights are detected within given regions in the images corresponding to the vehicle's side view mirrors, and/or if image processing from interior cameras on the vehicle identifies reflected light incident on the driver's face, the vehicle can determine that the headlights are likely to cause glare for the driver of the vehicle, and the glare condition can be satisfied. Other manners for determining whether a given headlight will cause glare for the driver described can be implemented. Additionally or alternatively to the techniques, whether a given light source satisfies the glare condition can depend on whether the brightness of that light source, in the images, is greater than (satisfying the glare condition) or less than (not satisfying the glare condition) a pixel brightness threshold. In some examples, this pixel brightness threshold can be automatically adjusted by the vehicle based on the ambient lighting conditions around the vehicle. For example, the brighter the ambient lighting is around the vehicle, the higher this pixel brightness threshold can be, and vice versa.

For example, the vehicle may not dim its side view mirrors in response to every light source it detects that satisfies the glare condition. Rather, the vehicle may only determine that the dimming condition is satisfied (e.g., and thus, trigger dimming of its side view mirrors) when the glare condition has been continuously satisfied for longer than a predetermined time period (or for more than a predetermined number of image frames) to avoid mirror dimming behavior that fluctuates rapidly (e.g., dimming for one second, followed by not dimming for one second, etc.).

If the dimming condition is not satisfied, method can determine to not dim the side view mirrors. If the dimming condition is satisfied, method can proceed to where the vehicle can dim its side view mirrors. Additionally or alternatively, in some examples, the amount of dimming of the vehicle's side view mirrors can be dynamic and/or variable. For example, the brighter the headlights in the images are, or the greater the brightness of the headlights is above the pixel brightness threshold, the more the vehicle can dim its side view mirrors. In some examples, the amount of side view mirror dimming can depend on the distance of the detected headlights from the vehicle. For example, the further away the headlights are, the less the vehicle can dim its side view mirrors. In some examples, the vehicle can determine the distance of the headlights from the vehicle based on the distance between pairs of headlights it identifies in the images. Specifically, the vehicle can assume that an automobile's headlights are separated from each other by a specified distance (or by a maximum distance, such as the width of a lane of a road, or an average distance between automobile headlights). By comparing this specified distance with the distance between the headlights in the captured images, the vehicle can determine the distance of the headlights from the vehicle (e.g., using trigonometric relationships between distance from the vehicle and distance between headlight pairs); the further away the headlights are, the closer together they can appear in the captured images, and vice versa.

In some examples, the windows of the vehicle can be tinted, while the cameras that capture the images can be external to the vehicle (and thus may not capture those images through the window tint). As a result, the brightness of headlights perceived by the driver of the vehicle can be different from the brightness of the headlights perceived by the cameras. In such situations, the dimming system of the vehicle can adjust itself (e.g., pixel brightness thresholds can be adjusted) to account for the reduction in light transmission into the interior of the vehicle caused by the window tint on the vehicle. For example, the darker the window tinting is, the greater the pixel brightness thresholds that are utilized by the vehicle can be (or the less dimming of the side view mirrors can be performed), and vice versa.

An exemplary system block diagram of vehicle control system according to examples of the disclosure. Vehicle control system can perform any of the methods. System can be incorporated into a vehicle, such as a consumer automobile. Other example vehicles that may incorporate the system include, without limitation, airplanes, boats, or industrial automobiles. Vehicle control system can include one or more cameras capable of capturing image data (e.g., video data) of the vehicle's surroundings. Vehicle control system can also include one or more other sensors (e.g., radar, ultrasonic, LIDAR, etc.) capable of detecting various characteristics of the vehicle's surroundings, and a Global Positioning System (GPS) receiver capable of determining the location of the vehicle. Vehicle control system can include an on-board computer that is coupled to the cameras, sensors and GPS receiver, and that is capable of receiving the image data from the cameras and/or outputs from the sensors and the GPS receiver. The on-board computer can be capable of identifying headlights trailing the vehicle and dimming mirrors on the vehicle (e.g., side view mirrors), as described in this disclosure. On-board computer can include storage, memory, and a processor. Processor can perform any of the methods. Additionally, storage and/or memory can store data and instructions for performing any of the methods. Storage and/or memory can be any non-transitory computer readable storage medium, such as a solid-state drive or a hard disk drive, among other possibilities. The vehicle control system can also include a controller capable of controlling one or more aspects of vehicle operation, such as dimming one or more mirrors (e.g., side view mirrors) as determined by the on-board computer.

In some examples, the vehicle control system can be connected to (e.g., via controller) one or more actuator systems in the vehicle, one or more indicator systems in the vehicle and a mirror system in the vehicle. The one or more actuator systems can include, but are not limited to, a motor or engine, battery system, transmission gearing, suspension setup, brakes, steering system and door system. The vehicle control system can control, via controller, one or more of these actuator systems during vehicle operation; for example, to open or close one or more of the doors of the vehicle using the door actuator system, to control the vehicle during autonomous driving or parking operations using the motor or engine, battery system, transmission gearing, suspension setup, brakes and/or steering system, etc. The one or more indicator systems can include, but are not limited to, one or more speakers in the vehicle (e.g., as part of an entertainment system in the vehicle), one or more lights in the vehicle, one or more displays in the vehicle (e.g., as part of a control or entertainment system in the vehicle) and one or more tactile actuators in the vehicle (e.g., as part of a steering wheel or seat in the vehicle). The vehicle control system can control, via controller, one or more of these indicator systems to provide indications to a driver of the vehicle of one or more characteristics of the vehicle's surroundings that are determined by the on-board computer, such as the existence and/or brightness of trailing headlights.

The mirror system can include dimmable (e.g., electrochromic mirrors), mirrors, such as side view mirrors on the vehicle. The on-board computer can, via controller, control the amount of dimming of the mirrors in the mirror system, as described in this disclosure.

Thus, the examples of the disclosure provide various ways to control the dimming of mirrors on a vehicle using one or more cameras on the vehicle.

Therefore, according to the above, some examples of the disclosure are directed to a vehicle comprising: one or more dimmable mirrors; one or more cameras configured to capture images of surroundings of the vehicle; and one or more processors coupled to the one or more dimmable mirrors and the one or more cameras, the one or more processors configured to: identify one or more headlights of another vehicle in the captured images; determine whether the one or more headlights satisfy mirror dimming criteria, including a criterion that is satisfied when the one or more headlights are located in a respective region of the captured images; in accordance with a determination that the one or more headlights satisfy the mirror dimming criteria, dim the one or more dimmable mirrors based on one or more characteristics of the one or more headlights; and in accordance with a determination that the one or more headlights do not satisfy the mirror dimming criteria, forgo dimming the one or more dimmable mirrors. Additionally or alternatively to one or more of the examples disclosed above, in some examples, the one or more dimmable mirrors include one or more side view mirrors. Additionally or alternatively to one or more of the examples disclosed above, in some examples, the vehicle does not include a rear view mirror, and at least one of the one or more cameras performs functionality of the rear view mirror. Additionally or alternatively to one or more of the examples disclosed above, in some examples, the surroundings of the vehicle comprise the rear surroundings of the vehicle.

Additionally or alternatively to one or more of the examples disclosed above, in some examples, identifying the one or more headlights of another vehicle comprises identifying a light source as a headlight in accordance with a determination that the light source is a point source. Additionally or alternatively to one or more of the examples disclosed above, in some examples, identifying the one or more headlights of another vehicle comprises identifying a light source as a headlight in accordance with a determination that movement of the light source in the images over time has specified characteristics. Additionally or alternatively to one or more of the examples disclosed above, in some examples, the movement of the light source in the images over time has the specified characteristics when the light source moves less than a threshold distance during a threshold time. Additionally or alternatively to one or more of the examples disclosed above, in some examples, identifying the one or more headlights of another vehicle comprises identifying a light source as a headlight in accordance with a determination that the light source is located in a specified region in the images. Additionally or alternatively to one or more of the examples disclosed above, in some examples, the specified region comprises a road in the images. Additionally or alternatively to one or more of the examples disclosed above, in some examples, the specified region comprises a region below a horizon in the images. Additionally or alternatively to one or more of the examples disclosed above, in some examples, the specified region in the images changes as a function of one or more characteristics of a road on which the vehicle is traveling. Additionally or alternatively to one or more of the examples disclosed above, in some examples, the one or more processors are configured to determine the one or more characteristics of the road based on at least one of a steering angle of the vehicle, a GPS location of the vehicle, and image processing of the images. Additionally or alternatively to one or more of the examples disclosed above, in some examples, the respective region in the captured images corresponds to a region with respect to the vehicle that is visible to the driver via at least one of the one or more dimmable mirrors. Additionally or alternatively to one or more of the examples disclosed above, in some examples, the mirror dimming criteria include a criterion that is satisfied when the vehicle determines, using an interior camera of the vehicle, that light reflected from the one or more dimmable mirrors is incident on a face of a driver of the vehicle.

Additionally or alternatively to one or more of the examples disclosed above, in some examples, the mirror dimming criteria include a criterion that is satisfied when the one or more headlights are located in the respective region of the captured images for longer than a predetermined time. Additionally or alternatively to one or more of the examples disclosed above, in some examples, the mirror dimming criteria include a criterion that is satisfied when an amount of ambient light in the surroundings of the vehicle is less than a threshold amount. Additionally or alternatively to one or more of the examples disclosed above, in some examples, the mirror dimming criteria include a criterion that is satisfied when a brightness of the one or more headlights in the captured images is greater than a brightness threshold. Additionally or alternatively to one or more of the examples disclosed above, in some examples, the brightness threshold changes as a function of an amount of ambient light in the surroundings of the vehicle. Additionally or alternatively to one or more of the examples disclosed above, in some examples, the brightness threshold is based on an amount of window tinting on the vehicle. Additionally or alternatively to one or more of the examples disclosed above, in some examples, the one or more characteristics of the one or more headlights comprise a distance of the one or more headlights from the vehicle. Additionally or alternatively to one or more of the examples disclosed above, in some examples, the one or more processors are configured to determine the distance of the one or more headlights from the vehicle based on a distance between a pair of headlights in the one or more headlights. Additionally or alternatively to one or more of the examples disclosed above, in some examples, the one or more processors are configured to: independently dim a first mirror of the one or more dimmable mirrors and a second mirror of the one or more dimmable mirrors.

Some examples of the disclosure are directed to a method comprising: capturing images of surroundings of a vehicle, the vehicle including one or more dimmable mirrors; identifying one or more headlights of another vehicle in the captured images; determining whether the one or more headlights satisfy mirror dimming criteria, including a criterion that is satisfied when the one or more headlights are located in a respective region of the captured images; in accordance with a determination that the one or more headlights satisfy the mirror dimming criteria, dimming the one or more dimmable mirrors based on one or more characteristics of the one or more headlights; and in accordance with a determination that the one or more headlights do not satisfy the mirror dimming criteria, forgoing dimming the one or more dimmable mirrors.

Some examples of the disclosure are directed to a non-transitory computer-readable medium including instructions, which when executed by one or more processors, cause the one or more processors to perform a method comprising: capturing images of surroundings of a vehicle, the vehicle including one or more dimmable mirrors; identifying one or more headlights of another vehicle in the captured images; determining whether the one or more headlights satisfy mirror dimming criteria, including a criterion that is satisfied when the one or more headlights are located in a respective region of the captured images; in accordance with a determination that the one or more headlights satisfy the mirror dimming criteria, dimming the one or more dimmable mirrors based on one or more characteristics of the one or more headlights; and in accordance with a determination that the one or more headlights do not satisfy the mirror dimming criteria, forgoing dimming the one or more dimmable mirrors.

What is claimed:

1. A vehicle system for assistance drivers to reduce reflective light interference from rear sides, comprising:
a plurality of dimmable mirrors;
a camera configured to capture images of a driver of the vehicle, the images including facial expressions comprising i) an eye of the driver and ii) head movement of the driver; and
a processor coupled to the camera, the processor configured to:
identify, in the captured images, i) any eyes squinting action of the driver relating to the eye and ii) any sudden head side movements when detected the eyes squinting action of the driver;
determine whether the identification may satisfy mirror dimming criteria, including a criterion that is satisfied when the plurality of dimmable mirrors are switched on;
in accordance with a determination that the identification does satisfy the mirror dimming criteria, a) dim a dimmable mirror based on one or more characteristics of the facial expressions of the driver including i) a direction of turning of the head of the driver and ii) whether the eye is a left eye or right eye, and b) leave rest of the plurality of the dimmable mirrors unchanged; and
in accordance with a determination that the one or more identification does not satisfy the mirror dimming criteria, forgo dimming the dimmable mirror.

2. The system of claim 2, wherein the identification of any eyes squinting action of the driver includes detection of changes of size of the eyes of the driver over a period of given time.

3. The system of claim 1, wherein the identification of any sudden head side movements includes an angle of tilting of the head of the driver from a normalized position captured in a previous image.

4. The system of claim 1, wherein an amount of dimming the dimmable mirror is determined by an amount of the eyes squinting action of the driver including the change of the size of the eyes over a period of time.

5. The system of claim 1, wherein an amount of dimming the dimmable mirror is determined by level or degree of the sudden head side movements include the angle of tilting of the head of the driver from a normalized position captured in a previous image over a period of time.

6. The system of claim 1, wherein the identification in the captured images, besides from the detecting the eyes squinting action and side movements, also includes any detection of glare or bright spots in the captured image shown on the face of the driver.

7. A vehicle system for assistance drivers to reduce reflective light interference from rear, comprising:
a plurality of dimmable mirrors;
a camera configured to capture images of a driver of the vehicle, the images including facial expressions comprising i) an eye of the driver and ii) head movement of the driver; and
a processor coupled to the camera, the processor configured to:
identify, in the captured images, i) any eyes squinting action of the driver relating to the eye ii) any sudden head side movements when detected the eyes squinting action of the driver, and iii) any detection of glare or bright spots in the captured image shown on the face of the driver,
wherein the identification of any eyes squinting action of the driver includes detection of changes of size of the eyes of the driver over a period of given time, and
wherein the identification of any sudden head side movements includes an angle of tilting of the head of the driver from a normalized position captured in a previous image;
determine whether the identification may satisfy mirror dimming criteria, including a criterion that is satisfied when the plurality of dimmable mirrors are switched on;
in accordance with a determination that the identification does satisfy the mirror dimming criteria, a) dim a dimmable mirror based on one or more characteristics of the facial expressions of the driver including i) a direction of turning of the head of the driver and ii) whether the eye is a left eye or right eye, wherein an amount of dimming the dimmable mirror is determined by an amount of the eyes squinting action of the driver including the change of the size of the eyes over a period of time, and wherein an amount of dimming the dimmable mirror is determined by level or degree of the sudden head side movements include the angle of tilting of the head of the driver from a normalized position captured in a previous image over a period of time and b) leave rest of the plurality of the dimmable mirrors unchanged; and
in accordance with a determination that the one or more identification does not satisfy the mirror dimming criteria, forgo dimming the dimmable mirror.

8. Methods for assistance drivers to reduce reflective light interference from rear, comprising:
capturing images of a driver of a vehicle, wherein the images including facial expressions comprising i) an eye of the driver and ii) head movement of the driver;
identifying, in the captured images,
i) any eyes squinting action of the driver relating to the eye
ii) any sudden head side movements when detected the eyes squinting action of the driver, and
iii) any detection of glare or bright spots in the captured image shown on the face of the driver,
wherein the identification of any eyes squinting action of the driver includes detection of changes of size of the eyes of the driver over a period of given time, and
wherein the identification of any sudden head side movements includes an angle of tilting of the head of the driver from a normalized position captured in a previous image;
determining whether the identification may satisfy mirror dimming criteria, including a criterion that is satisfied when the plurality of dimmable mirrors are switched on;
in accordance with a determination that the identification does satisfy the mirror dimming criteria:
a) dimming a dimmable mirror based on one or more characteristics of the facial expressions of the driver including:
i) a direction of turning of the head of the driver and
ii) whether the eye is a left eye or right eye,
wherein an amount of dimming the dimmable mirror is determined by an amount of the eyes squinting action of the driver including the change of the size of the eyes over a period of time, and
wherein an amount of dimming the dimmable mirror is determined by level or degree of the sudden head side movements include the angle of tilting of the head of the driver from a normalized position captured in a previous image over a period of time and
b) leaving rest of the plurality of the dimmable mirrors unchanged;
and in accordance with a determination that the one or more identification does not satisfy the mirror dimming criteria, forgo dimming the dimmable mirror.
